(19) United States
(12) Patent Application Publication
(10) Pub. No.: US 2006/0063084 A1
(43) Pub. Date: Mar. 23, 2006

(54) Emulsion aggregation toner containing pigment having a small particle size

(75) Inventors: Maura A. Sweeney, Rochester, NY (US); Dieu M. Nguyen, Rochester, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 10/945,970

(22) Filed: Sep. 22, 2004

(51) Int. Cl. G03G 9/08

(52) U.S. Cl. 430/108.7; 430/108.1; 430/137.14; 430/126

(57) ABSTRACT

Toner, particularly toner made by emulsion aggregation, containing binder resin and colorant containing a pigment dispersion containing pigment particles having an average particle diameter of from about 1 to about 150 nm and/or a pigment dispersion that is transparent.

### BACKGROUND OF THE INVENTION

1. Field of Invention

The invention relates to toner, particularly toner made by emulsion aggregation, containing binder resin and colorant containing pigment having a small average particle size.

2. Description of Related Art

It is known in the art to form toners by aggregating a colorant with a latex polymer. For example, U.S. Pat. No. 5,853,943 (hereinafter “the 943 patent”), which is herein incorporated by reference, is directed to a semi-continuous emulsion polymerization process for preparing a latex by first forming a seed polymer. In particular, the 943 patent describes a process comprising: (a) conducting a monomer emulsification which comprises emulsification of polymerization reagents including monomer in water to form a monomer emulsion; (b) preparing a seed particle latex by aqueous emulsion polymerization of a mixture comprised of part of the monomer emulsion and a free radical initiator; (c) heating and feed adding to the formed seed particles the remaining monomer emulsion, and optionally a free radical initiator, to prepare the latex polymer; (d) aggregating a colorant dispersion with the latex polymer; (e) coalescing or fusing the aggregates generated thereby.

In known emulsion polymerization processes, surfactants (that is, emulsifiers) are often used to stabilize the emulsion during emulsion polymerization. The presence of good surfactants can be important for stabilizing the emulsion polymerization process. However, the same surfactants that contribute advantage in the emulsion polymerization step can be detrimental to the functional properties or processing of the final toners. In particular, the presence of surfactants, particularly nonionic surfactants, can contribute to problems such as filter blinding, over-dispersed particles, persistent emulsion and/or, more importantly, undesirable final toner characteristics, such as sensitivity to relative humidity, low tribo charge, dielectric loss, aging and poor toner flow.

The colorant in toner may be a pigment and may be added to the latex polymer in the form of a pigment dispersion. The pigment particles in the pigment dispersion generally have an average particle size of greater than 200 nm.

### SUMMARY OF THE INVENTION

Whereas pigment dispersions often used for forming emulsion aggregation toner generally contain pigment particles having an average particle size of greater than 200 nm, pigment dispersions used for forming ink jet ink generally contain pigment particles having a smaller particle size and/or distribution.

In embodiments of the invention, toner, in particular emulsion aggregation toner, is formed using, as the colorant, at least one pigment dispersion known for forming ink jet ink.

In embodiments of the invention, toner, in particular emulsion aggregation toner, is formed using, as the colorant, at least one pigment dispersion containing pigment particles having an average particle diameter of from about 1 to about 150 nm, preferably from about 2 to about 125 nm, more preferably from about 5 to about 100 nm, and more preferably from about 10 to about 50 nm. In other embodiments, the pigment dispersion may contain pigment particles having a larger average particle diameter. In particular, pigments having an average particle diameter of from about 1 to about 1000 nm, preferably from about 2 to about 500 nm, and more preferably from about 5 to about 300 nm, may be used.

In embodiments of the invention, toner, in particular, emulsion aggregation toner, is formed using, as the colorant, at least one pigment dispersion that is transparent. As used herein, the term “transparent” refers to a pigment dispersion that has the property of transmitting light such that it can be easily seen through.

In embodiments, the invention is also directed to a method for forming an image using toner described herein. In particular, the invention includes an image forming process comprising: (a) charging a latent image carrier having a photoconductive layer; (b) forming an electrostatic latent image on the latent image carrier; (c) developing the electrostatic latent image with toner described herein to form a toner image; and (d) transferring the toner image to a receiving material.

### DETAILED DESCRIPTION OF PREFERRED EMBODIMENTS

In embodiments of the invention, the pigment used to form the toner is in a dispersion, preferably an aqueous dispersion.

In embodiments of the invention, toner is formed using, as the colorant, at least one pigment selected from the following list: various carbon blacks such as channel black, furnace black, lamp black, and the like. Colored pigments include red, green, blue, brown, magenta, cyan, and yellow particles, as well as mixtures thereof. Illustrative examples of magenta pigments include 2,9-dimethyl-substituted quinacridone and anthraquinone dye, identified in the Color Index as CI 60710, CI Dispersed Red 15, a diazo dye identified in the Color Index as CI 26050, CI Solvent Red 19, and the like. Illustrative examples of suitable cyan pigments include copper tetra-4-(octadecyl sulfonamide) phthalocyanine, X-copper phthalocyanine pigment, listed in the Color Index as CI 74160, CI Pigment Blue, and Anthradanthrene Blue, identified in the Color Index as CI 69810, Special Blue X-2137, and the like. Illustrative examples of yellow pigments that can be selected include diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33,2,5-dimethoxy-4-sulfonanilide phenylazo-4′-chloro-2,5-dimethoxy acetoacetanilide, Permanent Yellow FGL, and the like. Additional examples of pigments include Raven.R™. 5250, Raven.R™. 5750, Raven.R™. 3500 and other similar carbon black products available from Columbia Company, Regal.R™. 330, Black Pearl.R™. L, Black Pearl.R™. 1300, and other similar carbon black products available from Cabot Company, Degussa carbon blacks such as Color Black.R™. series, Special Black.R™. series, Printtex.R™. series and Derussol.R™. carbon black dispersions available from Degussa Company, Hostafine.R™. series such as Hostafine.R™. Yellow GR (Pigment 13), Hostafine.R™. Yellow (Pigment 83), Hostafine.R™. Red FRLL (Pigment Red 9), Hostafine.R™. Rubine F6B (Pigment 184), Hostafine.R™. Blue 2G (Pigment Blue 15:3), Hostafine.R™. Black T (Pigment Black 7), and Hostafine.R™. Black TS (Pigment Black 7), available from Hoechst Celanese Corporation, Normandy Magenta RD-2400 (Paul Uhlich), Paliogen Violet 5100 (BASF), Paliogen Violet 5890 (BASF), Permanent Violet VT2645 (Paul Uhlich), Heliogen Green L8730 (BASF), Argyle Green XP-111-S (Paul Uhlich), Brilliant Green Toner GR 0991 (Paul Uhlich), Heliogen Blue L6900, L7020 (BASF), Heliogen Blue D6840, D7080 (BASF), Sudan Blue OS (BASF), PV Fast Blue B2GO1 (American Hoechst), Irgalite Blue BCA (Ciba-Geigy), Paliogen Blue 6470 (BASF), Sudan II (Matheson, Coleman, Bell), Sudan II (Matheson, Coleman, Bell), Sudan IV (Matheson, Coleman, Bell), Sudan Orange 6 (Aldrich), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991 K (BASF), Paliotol Yellow 1840 (BASF), Novoperm Yellow F61 (Hoechst), Novoperm Yellow FG1 (Hoechst), Permanent Yellow YE 0305 (Paul Uhlich), Lumogen Yellow D0790 (BASF), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Tolidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company)), Royal Brilliant Red RD-8192 (Paul Uhlich), Oracet Pink RF (Ciba-Geigy), Paliogen Red 3871 K (BASF), Paliogen Red 3340 (BASF), Lithol Fast Scarlet L4300 (BASF), CAB-O-JET 200 hydrophilic carbon black (Cabot Corp.), CAB-O-JET 300 hydrophilic carbon black (Cabot Corp.), and the like. Additional suitable commercially available pigment dispersions include the Hostafines available from Hoechst, including Hostafine Yellow HR and Hostafine Blue B2G, as well as dispersions available from BASF, including Disperse Black 00-6607, Luconyl Yellow 1250, Basoflex Pink 4810, Luconyl Blue 7050, and the like.

Additional examples of suitable hydrophilic pigment particles include the colored silica particles prepared as disclosed in, for example, U.S. Pat. No. 4,877,451 and U.S. Pat. No. 5,378,574, the disclosures of each of which are totally incorporated herein by reference. In particular, the pigment dispersion may contain pigment particles that has been surface-modified. Particularly, the pigment dispersion may be surface-modified to stabilize the pigment particles in the pigment dispersion.

Another embodiment of pigments are the self-dispersing pigments as mentioned in U.S. Pat. No. 6,641,653, U.S. Pat. No. 6,506,245, U.S. Pat. No. 6,478,863, the disclosures of each of which are totally incorporated herein by reference. In particular, the pigment may comprise hydrophilic porous silica particles with dyes covalently bonded to their surfaces. Particularly, the dyes may be covalently bonded to the surface of the silica particles through silane coupling agents. The dyes covalently bonded to the silica particles may be the same or different from each other.

In embodiments, the present invention is directed to processes for the preparation of toner that comprise blending pigment with a latex polymer prepared as illustrated herein and optionally with a flocculant and/or charge additives and/or other additives; heating the resulting mixture to form toner sized aggregates; and isolating the toner product, such as by filtration, thereafter optionally washing and drying the toner particles, such as in an oven, fluid bed dryer, freeze dryer, or spray dryer. In embodiments, the mixture of pigment with latex polymer and optionally with a flocculant and/or charge additives and/or other additives is heated at a temperature below the Tg of the latex polymer, preferably from about 25° C. to about 1° C. below the Tg of the latex polymer, for an effective length of time of, for example, 0.5 hour to about 2 hours, to form toner sized aggregates. In embodiments, the aggregate suspension is then heated at a temperature at or above the Tg of the latex polymer, for example from about 60° C. to about 120° C., to effect coalescence or fusion, thereby providing fused toner particles.

The latex polymer is generally present in the toner compositions in various effective amounts, such as from about 75 weight percent to about 98 weight percent of the toner, and the latex polymer size suitable for the processes of the present invention can be, for example, from about 50 nm to about 1000 nm, preferably from about 20 nm to about 250 nm in volume average diameter as measured by the Brookhaven nanosize particle analyzer. Other sizes and effective amounts of latex polymer may be selected in embodiments.

Within the toner compositions of the present invention, the pigment is present in any effective amount to achieve the desired degree of coloration. Typically, the pigment is present in an amount of from about 0.1 to about 15 percent by weight of the toner, preferably from about 2 to about 11 percent by weight of the toner, and more preferably from about 3 to about 8 weight percent by weight of the toner, although the amount can be outside these ranges.

Flocculants may be used in effective amounts of for example, from about 0.01 percent to about 10 percent by weight of the toner. Flocculants that may be used include, but are not limited to, polyaluminum chloride (PAC), zinc acetate (which is particularly used in polyester processes), dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, MIRAPOL.™. and ALKAQUAT.™. available from Alkaril Chemical Company, SANIZOL.™. (benzalkonium chloride), available from Kao Chemicals, and the like.

Charge additives may also be used in suitable effective amounts of, for example, from 0.1 to 5 weight percent by weight of the toner. Suitable charge additives include, but are not limited to, alkyl pyridinium halides, bisulfates, the charge control additives of U.S. Pat. Nos. 3,944,493, 4,007,293, 4,079,014, 4,394,430 and 4,560,635, which illustrates a toner with a distearyl dimethyl ammonium methyl sulfate charge additive, the disclosures of which are totally incorporated herein by reference, negative charge enhancing additives like aluminum complexes, and the like.

Other additives that may be used include, but are not limited to, waxes, which may act as a releasing agent.

Illustrative examples of latex polymers include, but are not limited to, poly(styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-butylacrylate), poly(styrene-butadiene), poly(styrene-isoprene), poly(styrene-butyl methacrylate), poly(styrene-butyl acrylate-acrylic acid), poly(styrene-butadiene-acrylic acid), poly(styrene-isoprene-acrylic acid), poly(styrene-butyl methacrylate-acrylic acid), poly(butyl methacrylate-butyl acrylate), poly(butyl methacrylate-acrylic acid), poly(styrene-butyl acrylate-acrylonitrile-acrylic acid), poly(acrylonitrile-butyl acrylate-acrylic acid), poly(styrene-butyl acrylate-2-carboxyethyl acrylate), poly(styrene-butadiene-2-carboxyethyl acrylate), poly(styrene-isoprene-2-carboxyethyl acrylate), poly(styrene-butyl methacrylate-2-carboxyethyl acrylate), poly(butyl methacrylate-butyl acrylate-2-carboxyethyl acrylate), poly(butyl methacrylate-2-carboxyethyl acrylate), poly(styrene-butyl acrylate-acrylonitrile-2-carboxyethyl acrylate), poly(acrylonitrile-butyl acrylate-2-carboxyethyl acrylate), branched/partially crosslinked copolymers of the above, and the like. In embodiments, the latex polymer is a polyester, particularly a sulfonated polyester, as described in U.S. Pat. Nos. 5,348,832 and 5,593,807, each of which is hereby incorporated by reference in its entirety.

The latex polymer is generally present in the toner compositions in various effective amounts, such as from about 75 weight percent to about 98 weight percent by weight of the toner. However, other effective amounts of latex polymer may be selected in embodiments.

The latex polymer may be formed by emulsion polymerization. In particular, a multi-stage emulsion polymerization process may be used.

One or more monomers may be used to form a latex polymer. Any suitable monomers may be used. Monomers particularly useful in the process include, but are not limited to, acrylic and methacrylic esters, styrene, vinyl esters of aliphatic acids, ethylenically unsaturated carboxylic acids and known crosslinking agents. Suitable ethylenically unsaturated carboxylic acids can be acrylic acid, methacrylic acid, itaconic acid, maleic acid, ftimaric acid, 2-carboxyethyl acrylate (βCEA), and the like. Preferably, more than one monomer is used. In particular, the monomers preferably include styrene, n-butyl acrylate and/or βCEA.

The latex polymer formed may or may not be crosslinked. Any suitable crosslinking agents may be used. Suitable crosslinking agents include, but are not limited to, divinyl benzene, divinyl toluene, diacrylates, dimethylacrylates, and the like.

The monomers may be mixed with water and surfactant to form an emulsion. The emulsification is generally accomplished at a temperature of about 5° C. to about 40° C. However, the emulsion may also be formed at higher temperatures in particular. To form an emulsion, the mixture is generally agitated using an appropriate mixing device, such as a vessel with an agitator, having one or multiple impellers, a vessel containing a high speed agitator, such as a homogenizer, or a vessel equipped with an external loop containing an in-line mixing device. The mixing speed required to form an emulsion is determined by the type of device used. The time required to form an emulsion is generally less if the mixture is agitated at a higher speed.

The surfactant used in forming the monomer emulsion may be any surfactant that will provide the desired emulsification and latex, as well as would not significantly affect negatively the toner functional properties. The surfactants that may be added include ionic and/or nonionic surfactants.

Nonionic surfactants that may be used include, but are not limited to, dialkylphenoxypoly(ethyleneoxy) ethanol, available from Rhone-Poulenac as IGEPAL CA-210.™., IGEPAL CA-520.™., IGEPAL CA-720.™., IGEPAL CO-890.™., IGEPAL CO-720.™., IGEPAL CO-290.™., IGEPAL CA-210.™., ANTAROX 890.™., ANTAROX 897.™. and TRITON X-100 and other ones in series. An effective concentration of the nonionic surfactant is in embodiments, for example, from about 0.01 to about 10 percent by weight, and preferably from about 0.1 to about 5 percent by weight of the monomers used to prepare the polymer layer.

Examples of ionic surfactants include anionic and cationic surfactants with examples of anionic surfactants being, for example, sodium dodecylsulfate (SDS), sodium dodecylbenzene sulfonate, sodium dodecylnaphthalene sulfate, dialkyl benzenealkyl, sulfates and sulfonates, abitic acid, available from Aldrich, NEOGEN R.™., NEOGEN SC.™. obtained from Kao, and the like. An effective concentration of the anionic surfactant generally employed is, for example, from about 0.01 to about 10 percent by weight, and preferably from about 0.1 to about 5 percent by weight of monomers used to prepare the polymer layer.

Examples of the cationic surfactants, which are usually positively charged, include, for example, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, MIRAPOL.™. and ALKAQUAT.™. available from Alkaril Chemical Company, SANIZOL.™. (alkyl benzalkonium chloride), available from Kao Chemicals, and the like, and mixtures thereof. This surfactant is utilized in various effective amounts, such as for example from about 0.1 percent to about 5 percent by weight of water.

In addition, a chain transfer agent is preferably added to the monomer emulsion to control the molecular weight properties of the polymer to be formed. Chain transfer agents that may be used in the present invention include, but are not limited to, dodecanethiol, butanethiol, isooctyl-3-mercaptopropionate (10 MP), 2-methyl-5-t-butylthiophenol, carbon tetrachloride, carbon tetrabromide, and the like. Chain transfer agents may be used in any effective amount, such as from about 0.1 to about 10 percent by weight of the monomer in the monomer emulsion.

The polymer may be formed by first forming a seed polymer. To form a seed polymer, a portion of the monomer emulsion may be added to an aqueous phase. The aqueous phase may contain less than 20% by weight of the total amount of surfactant used in forming the latex polymer. Preferably, the aqueous phase contains from 0.5 to 10% by weight of the total amount of the surfactant used in forming the latex polymer. In a further preferred embodiment, the aqueous phase contains less than 3% by weight surfactant. Any surfactant, including the ones listed above, may be included in the aqueous phase and the surfactant in the aqueous phase may be the same or different from the surfactant used in forming the monomer emulsion.

The portion of the monomer used to form the seed polymer may be from about 0.25 to about 25 percent by weight of the total amount of monomer used to prepare the latex polymer. Preferably, the amount of monomer used to form the seed polymer is from about 0.5 to 10 percent by weight, more preferably from about 0.5 to 3 percent by weight, of the total amount of monomer used to form the latex polymer.

A polymerization initiator may be mixed with monomer emulsion, or added separately to the aqueous phase to form seed polymer. The initiator may be a free radical initiator and may attach to the polymer forming ionic, hydrophilic end groups on the polymer. Suitable initiators include, but are not limited to, ammonium persulfate, potassium persulfate, sodium persulfate, ammonium persulfite, potassium persulfite, sodium persulfite, ammonium bisulfate, sodium bisulfate, 1,1′-azobis(1-methylbutyronitrile-3-sodium sulfonate), 4,4′-azobis(4-cyanovaleric acid) hydrogen peroxide, t-butyl hydroperoxide, cumene hydroperoxide, para-methane hydroperoxide, benzoyl peroxide, tert-butyl peroxide, cumyl peroxide, 2,2′-azobisisobutyronitrile, 2,2′-azobis(2-methyl-butyronitrile), 2,2′-azobis(2-amidinopropane)dihydrochloride, 2,2′-azobisisobutyl amide dihydrate, 2,2′-azobis[2-(2-imidazolin-2-yl)propane]dihydrochloride, and 2,2′-azobis[2-(5-methyl-2-imidazolin-2-yl)propane]dihydrochloride. Preferably, the initiator is a persulfate initiator such as ammonium persulfate, potassium persulfate, sodium persulfate and the like. The initiator is generally added as part of an initiator solution in water.

The amount of initiator used to form the latex polymer may be from about 0.1 to about 10 percent by weight of the monomer to be polymerized. From 5 to 100 percent by weight, and preferably from 30 to 100 percent by weight, of the total amount of initiator to be used to prepare the latex polymer may be added during the seed polymerization stage.

In forming seed polymer, the emulsion polymerization may be conducted at a temperature of from about 35° C. to about 150° C., preferably from about 500 to about 95° C. The initiator may be added to the emulsion fairly slowly in order to maintain the stability of the system. For example, the initiator is preferably added over the course of at least 5 minutes, more preferably over the course of at least 10 minutes.

After formation of a seed polymer, additional monomer is added to complete the polymerization. The additional monomer may be in the form of a monomer emulsion. In embodiments, the additional monomer is the remainder of the monomer emulsion that was partially used in forming the seed polymer. The emulsion polymerization may be conducted at a temperature of from about 35° C. to about 150° C., preferably from about 50° C. to about 95° C. The additional monomer may be fed to the composition at an effective time period of, for example, 0.5 to 8 hours, preferably 2 to 6 hours.

In addition, additional initiator may or may not be added after the seed polymerization. If additional initiator is added during this phase of the reaction, it may or may not be of the same type as the initiator added to form the seed polymer.

A polyester latex polymer may be formed by condensation polymerization of a diol with a diacid or diester. Condensation polymerization processes are known in the art. In addition, condensation polymerization processes are described in U.S. Pat. Nos. 5,348,832, 5,466,554 and 5,593,807, each of which is hereby incorporated by reference in its entirety.

Examples of diols include, but are not limited to, ethylene glycol, 1,2-propylene glycol, 1,3-propylene glycol, 1,2-butylene glycol, 1,3-butylene glycol, 1,4-butylene glycol, 1,2-pentylene glycol, 1,3-pentylene glycol, 1,4-pentylene glycol, 1,5-pentylene glycol, 1,2-hexylene glycol, 1,3-hexylene glycol, 1,4-hexylene glycol, 1,5-hexylene glycol, 1,6-hexylene glycol, heptylene glycols, octylene glycols, decalyne glycol, dodecylyne glycol, 2,2-dimethyl propanediol, propoxylated bisphenol A, ethoxylated bisphenol A, 1,4-cyclohexane diol, 1,3-cyclohexane diol, 1,2-cyclohexane diol, 1,2-cyclohexane dimethanol, 2-propanediol, mixtures thereof, and the like. This component is employed in various effective amounts of, for example, from about 45 to about 55 mole percent by weight of the polyester product resin.

Examples of diacids or diesters include, but are not limited to, malonic acid, succinic acid, 2-methyl succinic acid, 2,3-dimethylsuccinic acid, dodecylsuccinic acid, glutaric acid, adipic acid, 2-methyladipic acid, pimelic acid, azeilic acid, sebacic acid, terephthalic acid, isophthalic acid, phthalic acid, 1,2-cyclohexanedioic acid, 1,3-cyclohexanedioic acid, 1,4-cyclohexanedioic acid, glutaric anhydride, succinic anhydride, dodecylsuccinic anhydride, maleic anhydride, fumaric acid, maleic acid, itaconic acid, 2-methylitaconic acid, dialkyl esters, wherein the alkyl groups are of one carbon chain to 23 carbon chains, and are esters of malonate, succinate, 2-methylsuccinate, 2,3-dimethylsuccinate, dodecylsuccinate, glutarate, adipic acid, 2-methyladipate, pimelate, azeilate, sebacate acid, terephthalate, isophthalate, phthalate, 1,2-cyclohexanedioate, 1,3-cyclohexanedioate, 1,4-cyclohexanedioate, mixtures thereof, and the like. This component is employed in effective amounts of, for example, from about 45 to about 55 mole percent by weight of the resin.

Specific examples of polycondensation catalysts include, but are not limited to, tetraalkyl titanates, dialkyltin oxide, tetraalkyltin, dialkyltin oxide hydroxide, aluminum alkoxides, alkyl zinc, dialkyl zinc, zinc oxide, stannous oxide, butyltin oxide, dibutyltin oxide, butyltin oxide hydroxide, tetraalkyl tin, such as dibutyltin dilaurate, and mixtures thereof, and which catalysts are selected in effective amounts of from about 0.01 mole percent to about 1 mole percent of polyester product resin.

The following examples illustrate specific embodiments of the present invention. One skilled in the art will recognize that the appropriate reagents, component ratio/concentrations may be adjusted as necessary to achieve specific product characteristics. All parts and percentages are by weight unless otherwise indicated.

### EXAMPLES

### Example I

A latex emulsion prepared by the semicontinuous emulsion polymerization of styrene/butyl acrylate/acrylic acid, 76.5/24.5/3 parts by weight, was used as the core and shell resin.

251.0 Grams of the above prepared latex emulsion containing 40% solids, 62 gm (6%) of a 44.4 nm transparent yellow 74 pigment dispersion containing 19% pigment and 1.65% surfactant Neogen RK, and 58 gm polyethylene wax dispersion containing 40% wax solids and 1.5% Neogen RK were simultaneously added to 430 milliliters of water with high shear stirring at 4,000 rpm for 2 minutes by means of a IKA-T50 homogenizer. The coagulant polyaluminum chloride dispersed in nitric acid (0.02 M) was added drop wise until incorporated and the slurry was mixed using high shear stirring for 20-30 minutes. The resulting mixture was then transferred to a 2 liter reaction vessel and heated at a temperature of 58° C. for 230 minutes until the mix aggregates and a shell is added. The particle size obtained was 6.0 microns (volume average diameter) with a GSD=1.23 as measured on the Coulter Counter. Subsequently, the mixture was heated to 96° C. and held there for a period of 4.5 hours before cooling down to room temperature, about 25° C. throughout, filtered, washed with water, and dried in a freeze dryer. The final toner product evidenced a particle size of 5.95 microns in volume average diameter with a particle size distribution of 1.23 as measured on a Coulter Counter. The toner was shown to have a percent projection efficiency of 68.2 on 1.0 TMA.

### Example II

A latex emulsion prepared by the semicontinuous emulsion polymerization of styrene/butyl acrylate/acrylic acid, 76.5/24.5/3 parts by weight, was used as the core and shell resin.

251.0 Grams of the above prepared latex emulsion containing 40% solids, 68 gm (6%) of a 76.5 nm moderately opaque yellow 74 pigment dispersion containing 17% pigment and 1.65% surfactant Neogen RK, and 58 gm polyethylene wax dispersion containing 40% wax solids and 1.5% Neogen RK were simultaneously added to 430 milliliters of water with high shear stirring at 4,000 rpm for 2 minutes by means of a IKA-T50 homogenizer. The coagulant polyaluminum chloride dispersed in nitric acid (0.02 M) was added drop wise until incorporated and the slurry was mixed using high shear stirring for 20-30 minutes. The resulting mixture was then transferred to a 2 liter reaction vessel and heated at a temperature of 58° C. for 111 minutes until the mix aggregates and a shell is added. The particle size obtained was 5.9 microns (volume average diameter) with a GSD=1.24 as measured on the Coulter Counter. Subsequently, the mixture was heated to 96° C. and held there for a period of 4.5 hours before cooling down to room temperature, about 25° C. throughout, filtered, washed with water, and dried in a freeze dryer. The final toner product evidenced a particle size of 5.7 microns in volume average diameter with a particle size distribution of 1.24 as measured on a Coulter Counter. The toner was shown to have a percent projection efficiency of 62.8 on 1.0 TMA.

### Example III

A latex emulsion prepared by the semicontinuous emulsion polymerization of styrene/butyl acrylate/acrylic acid, 76.5/24.5/3 parts by weight, was used as the core and shell resin.

251.0 Grams of the above prepared latex emulsion containing 40% solids, 66 gm (6%) of a 176.5 nm opaque yellow 74 pigment dispersion containing 18% pigment and 1.65% surfactant Neogen RK, and 58 gm polyethylene wax dispersion containing 40% wax solids and 1.5% Neogen RK were simultaneously added to 430 milliliters of water with high shear stirring at 4,000 rpm for 2 minutes by means of a IKA-T50 homogenizer. The coagulant polyaluminum chloride dispersed in nitric acid (0.02 M) was added drop wise until incorporated and the slurry was mixed using high shear stirring for 20-30 minutes. The resulting mixture was then transferred to a 2 liter reaction vessel and heated at a temperature of 58° C. for 43 minutes until the mix aggregates and a shell is added. The particle size obtained was 5.95 microns (volume average diameter) with a GSD=1.22 as measured on the Coulter Counter. Subsequently, the mixture was heated to 96° C. and held there for a period of 4.5 hours before cooling down to room temperature, about 25° C. throughout, filtered, washed with water, and dried in a freeze dryer. The final toner product evidenced a particle size of 5.85 microns in volume average diameter with a particle size distribution of 1.22 as measured on a Coulter Counter. The toner was shown to have a percent projection efficiency of 51.5 on 1.0 TMA.

### Example IV

A latex emulsion prepared by the semicontinuous emulsion polymerization of styrene/butyl acrylate/acrylic acid, 76.5/24.5/3 parts by weight, was used as the core and shell resin.

251.0 Grams of the above prepared latex emulsion containing 40% solids, 66 gm (6%) of a control 122.3 nm yellow 74 pigment dispersion containing 18% pigment and 1.65% surfactant Neogen RK, and 58 gm polyethylene wax dispersion containing 40% wax solids and 1.5% Neogen RK were simultaneously added to 430 milliliters of water with high shear stirring at 4,000 rpm for 2 minutes by means of a IKA-T50 homogenizer. The coagulant polyaluminum chloride dispersed in nitric acid (0.02 M) was added drop wise until incorporated and the slurry was mixed using high shear stirring for 20-30 minutes. The resulting mixture was then transferred to a 2 liter reaction vessel and heated at a temperature of 58° C. for 290 minutes until the mix aggregates and a shell is added. The particle size obtained was 5.65 microns (volume average diameter) with a GSD=1.26 as measured on the Coulter Counter. Subsequently, the mixture was heated to 96° C. and held there for a period of 4.5 hours before cooling down to room temperature, about 25° C. throughout, filtered, washed with water, and dried in a freeze dryer. The final toner product evidenced a particle size of 5.45 microns in volume average diameter with a particle size distribution of 1.26 as measured on a Coulter Counter. The toner was shown to have a percent projection efficiency of 65.6 on 1.0 TMA.

TABLE 1
Pigment Yellow 74

| | | | | | | % Projection | |
|---|---|---|---|---|---|---|---|
| | | Particle Size | Aggregation | Particle Size | GSD | Efficiency | % PE |
| Example | Description | (nm) | Time (min) | (Vol.-μm) | (Vol.) | (0.5 TMA) | (1.0 TMA) |
| Example I | Transparent Inkjet | 44.4 | 230 | 5.95 | 1.23 | 67.9 | 68.2 |
| | Yellow Pigment | | | | | | |
| Example II | Moderate Opaque | 76.5 | 111 | 5.7 | 1.24 | 60.2 | 62.8 |
| | Yellow Pigment | | | | | | |
| Example III | Opaque Yellow | 176.5 | 43 | 5.85 | 1.22 | 54.8 | 51.5 |
| | Pigment | | | | | | |
| Example IV | Control Pigment | 122.3 | 290 | 5.45 | 1.26 | 63.2 | 65.6 |

### Example V

A latex emulsion prepared by the semicontinuous emulsion polymerization of styrene/butyl acrylate/acrylic acid, 76.5/24.5/3 parts by weight, was used as the core and shell resin.

251.0 Grams of the above prepared latex emulsion containing 40% solids, 66 gm (6%) of a transparent 150 nm magenta 122 pigment dispersion (primary pigment projection efficiency of 87.5%) containing 17% pigment and 1.65% surfactant Neogen RK, and 58 gm polyethylene wax dispersion containing 40% wax solids and 1.5% Neogen RK, were simultaneously added to 430 milliliters of water with high shear stirring at 4,000 rpm for 2 minutes by means of a IKA-T50 homogenizer. The coagulant polyaluminum chloride dispersed in nitric acid (0.02 M) was added drop wise until incorporated and the slurry was mixed using high shear stirring for 20-30 minutes. The resulting mixture was then transferred to a 2 liter reaction vessel and heated at a temperature of 58° C. for 97 minutes until the mix aggregates to the appropriate size and a shell is added. The particle size obtained was 5.80 microns (volume average diameter) with a GSD=1.25 as measured on the Coulter Counter. Subsequently, the mixture was heated to 96° C. and held there for a period of 4.5 hours before cooling down to room temperature, about 25° C. throughout, filtered, washed with water, and dried in a freeze dryer. The final toner product evidenced a particle size of 5.63 microns in volume average diameter with a particle size distribution of 1.24 as measured on a Coulter Counter. The toner was shown to have a percent projection efficiency of 69.4 on 1.0 TMA.

### Example VI

A latex emulsion prepared by the semicontinuous emulsion polymerization of styrene/butyl acrylate/acrylic acid, 76.5/24.5/3 parts by weight, was used as the core and shell resin.

251.0 Grams of the above prepared latex emulsion containing 40% solids, 69 gm (6%) of an opaque 180 nm magenta 122 pigment dispersion (primary pigment projection efficiency of 83.2%) containing 19% pigment and 1.65% surfactant Neogen RK, and 58 gm polyethylene wax dispersion containing 40% wax solids and 1.5% Neogen RK were simultaneously added to 430 milliliters of water with high shear stirring at 4,000 rpm for 2 minutes by means of a IKA-T50 homogenizer. The coagulant polyaluminum chloride dispersed in nitric acid (0.02 M) was added drop wise until incorporated and the slurry was mixed using high shear stirring for 20-30 minutes. The resulting mixture was then transferred to a 2 liter reaction vessel and heated at a temperature of 58° C. for 93 minutes until the mix aggregates to the appropriate size and a shell is added. The particle size obtained was 5.78 microns (volume average diameter) with a GSD=1.25 as measured on the Coulter Counter. Subsequently, the mixture was heated to 96° C. and held there for a period of 4.5 hours before cooling down to room temperature, about 25° C. throughout, filtered, washed with water, and dried in a freeze dryer. The final toner product evidenced a particle size of 5.66 microns in volume average diameter with a particle size distribution of 1.25 as measured on a Coulter Counter. The toner was shown to have a percent projection efficiency of 68.4 on 1.0 TMA.

### Example VII

A latex emulsion prepared by the semicontinuous emulsion polymerization of styrene/butyl acrylate/acrylic acid, 76.5/24.5/3 parts by weight, was used as the core and shell resin.

251.0 Grams of the above prepared latex emulsion containing 40% solids, 67 gm (6%) of a control 160 nm magenta 122 pigment dispersion (primary pigment projection efficiency of 83.2%) containing 18% pigment and 1.65% surfactant Neogen RK, and 58 gm polyethylene wax dispersion containing 40% wax solids and 1.5% Neogen RK were simultaneously added to 430 milliliters of water with high shear stirring at 4,000 rpm for 2 minutes by means of a IKA-T50 homogenizer. The coagulant polyaluminum chloride dispersed in nitric acid (0.02 M) was added drop wise until incorporated and the slurry was mixed using high shear stirring for 20-30 minutes. The resulting mixture was then transferred to a 2 liter reaction vessel and heated at a temperature of 58° C. for 160 minutes until the mix aggregates to the appropriate size and a shell is added. The particle size obtained was 5.98 microns (volume average diameter) with a GSD=1.24 as measured on the Coulter Counter. Subsequently, the mixture was heated to 96° C. and held there for a period of 4.5 hours before cooling down to room temperature, about 25° C. throughout, filtered, washed with water, and dried in a freeze dryer. The final toner product evidenced a particle size of 5.81 microns in volume average diameter with a particle size distribution of 1.24 as measured on a Coulter Counter. The toner was shown to have a percent projection efficiency of 68 on 1.0 TMA.

TABLE 2
Pigment Red 122

| | | % | | | | | % Projection | % PE |
|---|---|---|---|---|---|---|---|---|
| | | Projection | Particle | Aggregation | Particle Size | GSD | Efficiency | (1.0 |
| Example | Description | Efficiency | Size (nm) | Time (min) | (Vol.-μm) | (Vol.) | (0.5 TMA) | TMA) |
| Example V | Transparent | 87.5 | 150 | 97 | 5.63 | 1.24 | 67.5 | 69.4 |
| | Inkjet | | | | | | | |
| | Magenta | | | | | | | |
| | Pigment | | | | | | | |
| Example VI | Opaque | 83.2 | 180 | 93 | 5.66 | 1.25 | 65.3 | 68.4 |
| | Magenta | | | | | | | |
| | Pigment | | | | | | | |
| Example VII | Control | 83.2 | 160 | 160 | 5.81 | 1.24 | 64.5 | 68 |
| | Pigment | | | | | | | |

### Example VIII

A latex emulsion prepared by the semicontinuous emulsion polymerization of styrene/butyl acrylate/acrylic acid, 76.5/24.5/3 parts by weight, was used as the core and shell resin.

251.0 Grams of the above prepared latex emulsion containing 40% solids, 36 gm (4%) of a transparent 137 nm cyan 15:3 pigment dispersion (primary pigment projection efficiency of 93.6%) containing 16% pigment and 1.65% surfactant Neogen RK, and 58 gm polyethylene wax dispersion containing 40% wax solids and 1.5% Neogen RK were simultaneously added to 430 milliliters of water with high shear stirring at 4,000 rpm for 2 minutes by means of a IKA-TSO homogenizer. The coagulant polyaluminum chloride dispersed in nitric acid (0.02 M) was added drop wise until incorporated and the slurry was mixed using high shear stirring for 20-30 minutes. The resulting mixture was then transferred to a 2 liter reaction vessel and heated at a temperature of 58° C. until the mix aggregates to the appropriate size and a shell is added. The particle size obtained was 5.68 microns (volume average diameter) with a GSD=1.24 as measured on the Coulter Counter. Subsequently, the mixture was heated to 96° C. and held there for a period of 4.5 hours before cooling down to room temperature, about 25° C. throughout, filtered, washed with water, and dried in a freeze dryer. The final toner product evidenced a particle size of 5.56 microns in volume average diameter with a particle size distribution of 1.23 as measured on a Coulter Counter. The toner was shown to have a percent projection efficiency of 80.7 on 1.0 TMA.

### Example IX

A latex emulsion prepared by the semicontinuous emulsion polymerization of styrene/butyl acrylate/acrylic acid, 76.5/24.5/3 parts by weight, was used as the core and shell resin.

251.0 Grams of the above prepared latex emulsion containing 40% solids, 38 gm (4%) of an opaque 146 nm cyan 15:3 pigment dispersion (primary pigment projection efficiency of 83.2%) containing 17% pigment and 1.65% surfactant Neogen RK, and 58 gm polyethylene wax dispersion containing 40% wax solids and 1.5% Neogen RK were simultaneously added to 430 milliliters of water with high shear stirring at 4,000 rpm for 2 minutes by means of a IKA-T50 homogenizer. The coagulant polyaluminum chloride dispersed in nitric acid (0.02 M) was added drop wise until incorporated and the slurry was mixed using high shear stirring for 20-30 minutes. The resulting mixture was then transferred to a 2 liter reaction vessel and heated at a temperature of 58° C. until the mix aggregates to the appropriate size and a shell is added. The particle size obtained was 5.74 microns (volume average diameter) with a GSD=1.24 as measured on the Coulter Counter. Subsequently, the mixture was heated to 96° C. and held there for a period of 4.5 hours before cooling down to room temperature, about 25° C. throughout, filtered, washed with water, and dried in a freeze dryer. The final toner product evidenced a particle size of 5.64 microns in volume average diameter with a particle size distribution of 1.24 as measured on a Coulter Counter. The toner was shown to have a percent projection efficiency of 82.8 on 1.0 TMA.

### Example X

A latex emulsion prepared by the semicontinuous emulsion polymerization of styrene/butyl acrylate/acrylic acid, 76.5/24.5/3 parts by weight, was used as the core and shell resin.

251.0 Grams of the above prepared latex emulsion containing 40% solids, 38 gm (4%) of a control 183 nm cyan 15:3 pigment dispersion (primary pigment projection efficiency of 85%) containing 17% pigment and 1.65% surfactant Neogen RK, and 58 gm polyethylene wax dispersion containing 40% wax solids and 1.5% Neogen RK were simultaneously added to 430 milliliters of water with high shear stirring at 4,000 rpm for 2 minutes by means of a IKA-T50 homogenizer. The coagulant polyaluminum chloride dispersed in nitric acid (0.02 M) was added drop wise until incorporated and the slurry was mixed using high shear stirring for 20-30 minutes. The resulting mixture was then transferred to a 2 liter reaction vessel and heated at a temperature of 58° C. until the mix aggregates to the appropriate size and a shell is added. The particle size obtained was 5.78 microns (volume average diameter) with a GSD=1.25 as measured on the Coulter Counter. Subsequently, the mixture was heated to 96° C. and held there for a period of 4.5 hours before cooling down to room temperature, about 25° C. throughout, filtered, washed with water, and dried in a freeze dryer. The final toner product evidenced a particle size of 5.67 microns in volume average diameter with a particle size distribution of 1.25 as measured on a Coulter Counter. The toner was shown to have a percent projection efficiency of 83.4 on 1.0 TMA.

TABLE 3
Pigment Blue 15:3

| | | % | | | | % Projection | |
|---|---|---|---|---|---|---|---|
| | | Projection | Particle Size | Particle Size | GSD | Efficiency | % PE |
| Example | Description | Efficiency | (nm) | (Vol.-μm) | (Vol.) | (0.5 TMA) | (1.0 TMA) |
| Example VIII | Transparent | 93.6 | 137 | 5.56 | 1.23 | 75.3 | 80.7 |
| | Inkjet Cyan | | | | | | |
| | Pigment | | | | | | |
| Example IX | Opaque Cyan | 83.2 | 146 | 5.64 | 1.24 | 77.6 | 82.8 |
| | Pigment | | | | | | |
| Example X | Control Pigment | 85 | 183 | 5.67 | 1.25 | 80.9 | 83.4 |

### Example XI

a). Preparation of sulfonated polyester resin: dimethylterephthalate (388 grams), sodium dimethyl 5-sulfoisophthalate (44 grams), propanediol (302 grams), diethylene glycol (34.2) and butyltin oxide (0.8 gram) were charged in a 1 liter Parr reactor equipped with a mechanical stirrer and distillation apparatus. The mixture was heated to 175° C. for about 1 hour, and then the temperature was increased to 185° C. for an additional 3 hours during which time methanol byproduct was collected in the distillation receiver. The mixture was then raised to about 200° C., and the pressure was reduced from atmospheric pressure to about 0.5 Torrs over a period of about 2 hours. During this time, the excess glycol was collected in the distillation receiver. The product was then discharged through the bottom drain valve to result in the product, copoly(1,2-propylene-dipropylene-terephthalate)-copoly(1,2-propylene-dipropylene-5-sodiosulfo-isophthalate), with a glass transition temperature of about 54.6° C., a number average molecular weight (Mₙ) of 1,500 grams per mole, a weight average molecular weight (M_{w}) of 3,160 as measured by gel permeation chromatography using polystyrene as standard. 250 Grams of the above polyester resin were then heated with 750 grams of water at 75° C. for 1 hour to provide an emulsion of sulfonated polyester particles in water.

b). Toner preparation: 120 gm sulfonated polyester resin was mixed with 84 gm self-dispersing pigment red 122 (particle size 20 nm), 37 gm carnauba wax dispersed in anionic surfactant sodium lauryl sulfate and additional deionized water of 200 gm. The mixture was heated to 60° C. while adding a 1.5% solution of zinc acetate coagulant. The particles were grown to 5.51 microns in volume average diameter with a particle size distribution of 1.22 as measured on a Coulter Counter. The toner was shown to have a percent projection efficiency of 82 on 1.0 TMA.

### Example XII

a). Preparation of sulfonated polyester resin: as described in Example XI.

b). Toner preparation: 120 gm sulfonated polyester resin was mixed with 69 gm self-dispersing pigment red 122 (particle size 113 nm), 18 gm self-dispersing pigment violet 19 (particle size 101 nm), 51 gm carnauba wax dispersed in anionic surfactant sodium lauryl sulfate and additional deionized water of 200 gm. The mixture was heated to 60° C. while adding a 1.5% solution of zinc acetate coagulant. The particles were grown to 5.48 microns in volume average diameter with a particle size distribution of 1.20 as measured on a Coulter Counter. The toner was shown to have a percent projection efficiency of 78 on 1.0 TMA.

### Example XIII

a). Preparation of sulfonated polyester resin: as described in Example XI.

b). Toner preparation: 120 gm sulfonated polyester resin was mixed with 49 gm control pigment red 122 (particle size 220 nm), 37 gm carnauba wax dispersed in anionic surfactant sodium lauryl sulfate and additional deionized water of 200 gm. The mixture was heated to 60° C. while adding a 1.5% solution of zinc acetate coagulant. The particles were grown to 5.58 microns in volume average diameter with a particle size distribution of 1.20 as measured on a Coulter Counter. The toner was shown to have a percent projection efficiency of 69 on 1.0 TMA.

### Example XIV

a). Preparation of sulfonated polyester resin: as described in Example XI.

b). Toner preparation: 120 gm sulfonated polyester resin was mixed with 86 gm self dispersing pigment yellow 74 (particle size 107 nm), 51 gm carnauba wax dispersed in anionic surfactant sodium lauryl sulfate and additional deionized water of 200 gm. The mixture was heated to 60° C. while adding a 1.5% solution of zinc acetate coagulant. The particles were grown to 5.84 microns in volume average diameter with a particle size distribution of 1.23 as measured on a Coulter Counter. The toner was shown to have a percent projection efficiency of 88 on 1.0 TMA.

### Example XV

a). Preparation of sulfonated polyester resin: as described in Example XI.

b). Toner preparation: 120 gm sulfonated polyester resin was mixed with 83 gm control pigment yellow 74 (particle size 130 rm), 37 gm carnauba wax dispersed in anionic surfactant sodium lauryl sulfate and additional deionized water of 200 gm. The mixture was heated to 60° C. while adding a 1.5% solution of zinc acetate coagulant. The particles were grown to 5.92 microns in volume average diameter with a particle size distribution of 1.24 as measured on a Coulter Counter. The toner was shown to have a percent projection efficiency of 79 on 1.0 TMA.

### Example XVI

a). Preparation of sulfonated polyester resin: as described in Example XI.

b). Toner preparation: 120 gm sulfonated polyester resin was mixed with 81 gm self dispersing pigment blue 15:3 (particle size 96 nm), 51 gm carnauba wax dispersed in anionic surfactant sodium lauryl sulfate and additional deionized water of 200 gm. The mixture was heated to 60° C. while adding a 1.5% solution of zinc acetate coagulant. The particles were grown to 5.63 microns in volume average diameter with a particle size distribution of 1.22 as measured on a Coulter Counter. The toner was shown to have a percent projection efficiency of 70 on 1.0 TMA.

### Example XVII

a). Preparation of sulfonated polyester resin: as described in Example XI.

b). Toner preparation: 120 gm sulfonated polyester resin was mixed with 17 gm control pigment blue 15:3 (particle size 182 nm), 37 gm carnauba wax dispersed in anionic surfactant sodium lauryl sulfate and additional deionized water of 200 gm. The mixture was heated to 60° C. while adding a 1.5% solution of zinc acetate coagulant. The particles were grown to 5.65 microns in volume average diameter with a particle size distribution of 1.22 as measured on a Coulter Counter. The toner was shown to have a percent projection efficiency of 65 on 1.0 TMA.

TABLE 4

| | | Pigment | | | | | |
|---|---|---|---|---|---|---|---|
| | | Particle | G50 | GSD | G50 | GSD | |
| Example | Description | Size (nm) | (vol) | (vol) | (Num) | (Num) | PE (%) |
| Example XI | PR122 Self | 20 | 5.51 | 1.22 | 4.72 | 1.28 | 82 |
| Magenta Sample 1 | Dispersing Inkjet | | | | | | |
| | Pigment | | | | | | |
| Example XII | PV19/PR122 Self | 101 and | 5.48 | 1.2 | 4.83 | 1.25 | 78 |
| 29467-68-MAS-24 | Dispersing Inkjet | 113 | | | | | |
| | Pigment | | | | | | |
| Example XIII | PR122 Control | 220 | 5.58 | 1.2 | 4.8 | 1.27 | 69 |
| Magenta Sample 2 | (Coarse Pigment) | | | | | | |
| Example XIV | PY74 Self | 107 | 5.84 | 1.23 | 4.53 | 1.41 | 88 |
| Yellow Sample 1 | Dispersing Inkjet | | | | | | |
| | Pigment | | | | | | |
| Example XV | PY74 Control | 130 | 5.92 | 1.24 | 4.58 | 1.46 | 79 |
| Yellow Sample 2 | (Coarse Pigment) | | | | | | |
| Example XVI | PB15:4 Self | 96 | 5.63 | 1.22 | 4.83 | 1.29 | 70 |
| Cyan Sample 1 | Dispersing Inkjet | | | | | | |
| | Pigment | | | | | | |
| Example XVII | PB 15:3 Control | 182 | 5.65 | 1.22 | 4.91 | 1.28 | 65 |
| Cyan Sample 2 | (Coarse Particle) | | | | | | |

What is claimed is:

1. Toner formed by emulsion aggregation, comprising binder resin and colorant, wherein the colorant comprises at least one pigment having an average particle diameter of about 150 nm or less.

2. Toner according to claim 1, wherein said toner is formed by aggregating at least one latex resin and at least one pigment dispersion to form aggregates and coalescing said aggregates.

3. Toner according to claim 2, wherein said at least one pigment dispersion is transparent.

4. Toner according to claim 2, wherein said pigment is a surface-modified pigment.

5. Toner according to claim 4, wherein said surface-modified pigment has been surface-modified to stabilize the pigment in said pigment dispersion.

6. Toner according to claim 1, wherein said pigment comprises hydrophilic porous silica particles having surfaces to which dyes are covalently bonded.

7. Toner according to claim 6, wherein said dyes are covalently bonded through silane coupling agents.

8. Toner according to claim 1, wherein said pigment has an average particle diameter of from about 2 to about 125 nm.

9. Toner according to claim 1, wherein said pigment has an average particle diameter of from about 5 to about 100 nm.

10. Toner according to claim 1, wherein said pigment has an average particle diameter of from about 10 to about 50 nm.

11. Toner formed by aggregating at least one latex resin and, as a colorant, at least one pigment dispersion, wherein said pigment dispersion is transparent.

12. Toner according to claim 11, wherein said pigment dispersion comprises pigment particles having an average particle diameter of about 1 to about 1000 nm.

13. Toner according to claim 11, wherein said pigment dispersion comprises pigment particles having an average particle diameter of about 2 to about 500 nm.

14. Toner according to claim 11, wherein said pigment dispersion comprises pigment particles having an average particle diameter of about 5 to about 300 nm.

15. Toner according to claim 11, wherein said pigment dispersion comprises pigment particles having an average particle diameter of about 1 to about 150 nm.

16. Toner according to claim 11, wherein said pigment dispersion comprises pigment particles having an average particle diameter of about 2 to about 125 nm.

17. Toner according to claim 11, wherein said pigment dispersion comprises pigment particles having an average particle diameter of about 5 to about 100 nm.

18. Toner according to claim 11, wherein said pigment dispersion comprises pigment particles having an average particle diameter of about 10 to about 50 nm.

19. An image forming process comprising: (a) charging a latent image carrier having a photoconductive layer; (b) forming an electrostatic latent image on the latent image carrier; (c) developing the electrostatic latent image with a toner according to claim 1 to form a toner image; and (d) transferring the toner image to a receiving material.

20. An image forming process comprising: (a) charging a latent image carrier having a photoconductive layer; (b) forming an electrostatic latent image on the latent image carrier; (c) developing the electrostatic latent image with a toner according to claim 11 to form a toner image; and (d) transferring the toner image to a receiving material.
